(19) United States
(12) Patent Application Publication
(10) Pub. No.: US 2004/0139883 A1
(43) Pub. Date: Jul. 22, 2004

(54) Novel water based liquid ink and method of manufacturing the water based (aqueous) liquid inks for use in different types of ink jet printers

(76) Inventor: Harish Goswamy, Mumbai (IN)

Correspondence Address: KRIEGSMAN & KRIEGSMAN, 665 Franklin Street, Framingham, MA, 01702, US

(21) Appl. No.: 10/346,521

(22) Filed: Jan. 16, 2003

(51) Int. Cl. C09D 11/00

(52) U.S. Cl. 106/31.27; 106/31.32

(57) ABSTRACT

A novel water based inkjet ink and a process of manufacturing the water based (aqueous) liquid ink for use in different types of ink jet printers. The water based (aqueous) liquid ink for use in different types of ink jet printers, composition comprising of the Dye with salt content upto 15%, the Co-Solvents, Kogation Agent, Biocide, PH buffer, Conductivity agents and the balance being Deionised Water. The Dye with salt content upto 15% is present in a range of from about 0.1% to 12%, the Co-Solvents are present in a range of from about 0.1% to 30%, the Kogation Agent is present in a range of from about 0.01% to 2%, the Biocide is present in a range of from about 0.01% to 0.5%, PH buffer is present in a range of from about 0.01% to 3.0%, Conductivity agents are present in a range of from about with percent by weight of 0% to 3.0% and the balance being Deionised Water, whereby the ink is more conductive and thus requires lesser voltage.

### TECHNICAL FIELD

This invention relates, to a novel liquid water based ink with higher conductivity & method of manufacturing the water based (aqueous) liquid inks for use in different types of ink jet printers.

### BACKGROUND

The inkjet printing process is a non-contact printing processes which makes it possible to produce the colored or black images rapidly, quietly and in a high resolution. The process is usually carried out with aqueous inks, which are sprayed as small droplets directly onto the substrate. There is a continuous form of the process, in which the ink is pumped at a uniform rate through a nozzle and the jet is deflected onto the substrate such as paper, or in to an ink collector, by an electric field depending on the pattern to be printed. This method is known as the continuous inkjet printing.

Under another process, known as the drop-on-demand process, or DOD wherein we have the Piezo Type of Printers or the Thermal Type of printers.

In DOD the ink is made to eject out of the printhead only when the printing is required i.e. On Demand, unlike Continuous wherein there is a continuous flow of ink. The Piezo Type of Printers use material (Piezo Electric Crystals) which can change form and shape for a brief moment only when current is passed thru it and then regain the earlier shape. This change effects a pressure change wherein the ink is expelled from the print head and is printed onto a substrate.

In thermal type of printers—A heating element is heated for a split second causing a bubble to be formed which brings about a change in the volume of the ink inside the printhead once again expelling a tiny dot of ink which is printed on to the substrate.

An aqueous ink formulation for the use in inkjet printers customarily comprises synthetic organic dyes or pigments or a mixture thereof, organic solvents, wetting agents, biocide, pH buffer, defoamer and water among others. To obtain a good inkier print, the ink has to satisfy certain criteria as regards viscosity, surface tension, specific electrical conductivity, density and pH. These properties have to remain unchanged for a prolonged period to prevent troublesome precipitates in the cartridge or reservoirs or dramatic changes in viscosity and hence deterioration in the printout.

In continuous ink jet printing, ink is supplied under pressure to the orifices of the print head. The ink discharges from the orifices, in the form of a stream of drops under pressure. To print using this stream of drops of ink, one needs to selectively charge drops as per the requirement. The charging of the selected drops, thus change their angle of flow i.e. deflect it away from the stream of drops selectively so that the deflected drop can be converted into print on the substrate. The remaining drops i.e. the drops which have not been charged continue to flow in the stream and get collected in the collection device (or vice versa as the mechanism is set) which recycles the ink and thus making the process continuous as recycling shall continuously collect the ink which has not been deflected on to the substrate.

There are various patents on inks for inkjet ink for all different type of printers whereas our application is based mainly for Continuous Type of inkjet printers. However this in no way limits to scope of the invention for use in other type of non contact printing technologies.

In U.S. Pat. No. 5,624,485 of Scitex Digital—Daytona Ohio (Mentioned herein for reference only) they have mentioned inks for continuous inkjet type of printers wherein the quantity of the solvents used are upto 2.0% levels and the patent mentions that there is no substantial benefit in the use of excess solvent however it was surprising found by us that by use of additional quantity of solvent in the ink dries harder and faster at elevated temperatures when passed under the heater. Furthermore it was found that no mention to the conductivity of the ink or its role in the printing process is mentioned in the above mentioned patent whereas our patent gives complete details of the conductivity of the ink and how it helps to improve the functioning of the ink.

Other patents of interest include U.S. Pat. Nos. 5,948,152; 4,369,041; 4,563,190; 4,459,130; 4,849,770; 4,166,044; 5,462,592; 3,985,663 and 4,352,691.

### SUMMARY OF THE INVENTION

In the ink jet printing, the ink is pumped out through the print head. There are a number of print head manufacturers in the world. In the continuous printing method a number of parameters play an important part to determine the quality of the printing and the life of the print head. One of the factors in determining the quality of printing and the life of print head is the Voltage that is applied between the plates to produce the required deflection and the Phase applied to determine the clarity of the printing. The Voltage and the Phase are the functions of the quality of the ink as well as of the machine.

Every time a print head manufacturer supplies a print head for the machines, he mentions the optimum Voltage under which he considers the print head will work. The optimum Voltage under which the print head will work varies from print head to print head. The Voltage is set by the manufacturer based on the deflection angle that he has to set for the ink to work on a particular machine. Each printhead is warranted by its manufacturer for a certain nos. of hours during which it guarantees that the alignment on the nozzles will be remain steady and thus the collection of the ink droplets which have not been deflected or vice versa can be collected.

As a thumb rule in the inkjet industry the people using the continuous inkjet printing method, it is considered that, the lower the voltage setting for the print head the better it is for the life of the print head. That is the print head will last longer than if the voltage settings are kept lower. This is critical since the cost of each printhead is quite expensive and the warranty on the same is continuously being reduced/changed by the manufacturers of these printheads.

Further, each machine has a set angle of deflection of the ink so that the substrate on which the printing is to be carried out can be aligned with the print head and the printing can be carried out in a straight line. If, the angle of deflection is not set accurately i.e. is less or more, then the drops of ink can get accumulated in the print head and can create streaking and shorting.

The angle of deflection in the continuous inkjet printing can be changed in two ways either by changing the design of the print head or by increasing the conductivity of the ink and thus the ability to get charged of the ink.

When the conductivity of the ink is increased, the angle of deflection will automatically increase (since more electrically conductive the ink the more will be the angle of deflection at a certain Voltage) and thus to control the angle of deflection in the machine, the voltage required by the print head to create the potential difference between the plates and thereby create a deflection of the charged drops of ink passing between the plates has to be adjusted. It has been found that the conductivity of the ink to create the required angle of deflection for a specific machine and the voltage required by the print head are inversely proportional to each other.

Thus, when the voltage is increased, for a specific ink, with a certain conductivity, it will have a higher angle of deflection as compared to the same ink at a lower voltage. Thus, the angle of deflection can be controlled in the machine using the conductivity of the ink and the voltage being applied to the print head.

There by, the voltage requirement can be reduced by increasing the conductivity of the ink and thus improve the life of the print head.

Conductivity is a function of the quantity of the charged particles (mainly salts) in the ink. The greater the charge on particles, the greater is the conductivity of the ink.

There is however a limit to the conductivity that has to be set. When excess salt is present in the ink composition then, the same could lead to deterioration in the shelf life of the ink, as precipitation or crusting is noticed on the nozzles or orifices of the print head as well as in the storage bottles.

Thus, till date the ink manufacturers use components in the ink making process which are virtually free of salts and add any of the other conductivity agents separately if necessary.

It is observed that, most of the manufacturers use water soluble dyes with the salt content being practically nil i.e. less than 0.5%.

In the invention under consideration I have found that, the commercially available dyes with a salt content upto 15% can be used in manufacturing the water based (aqueous) liquid inks. The salt present in the dyes gets formed during the dye manufacturing process itself. There may or may not be a need to purify the dye before use of the dyes in the inkjet inks depending on the salt content in the dyestuffs. I have successfully made inks for inkjet applications using dyes containing upto 15% salt content. The salts of various types such as sodium, potassium, lithium, ammonium, magnesium, calcium and others in the form of their sulphates, chlorides, hydroxides, carbonates, bicarbonates and others are stable. There are some insoluble salts which are not considered in this invention. Thus, it may be inferred that, the soluble salts in general are the stable components.

In the invention under consideration, I have further advantageously found out that, these dyes with higher salt content are stable, than the one used in the inkjet industry currently, this can be used for making stable inkjet compositions, and having a good shelf life too. I have further found that, the excess salt content in the dyes helps in increasing the conductivity of the inks in such a way that the voltage and the phase requirements of the print head can be reduced thereby helping in improving the life of the print heads and thus making the ink more useful.

Further, as the said dyes are commercially available in the crude form, hence an ample choice of colors and the intensity of the colors are available. Considering this, a wide variety of dyes can be used in manufacturing the water based (aqueous) liquid inks for use in different types of ink jet printers. The synthetic organic dyes from different chemical families such as direct, acid, basic, reactive, food colors and others can be used in manufacturing the water based (aqueous) liquid inks for use in different types of ink jet printers.

### DETAILED DESCRIPTION OF THE INVENTION

The ink jet ink composition of the present invention can be used in DOD, Piezo, and/or preferably, on Continuous ink jet printers.

The Ink, consists of the water soluble commercially available dyes with salt content up to 15% level for coloration, co-solvents for faster drying of the ink, a pH modifier to maintain pH of the ink, biocide for the prevention of any formation of bacteria or fungus, kogation agents for the prevention of clogging of orifices, and the balance being water.

The inkjet composition according to the present invention is a mix and blend of a number of products and provide for a dark, quick drying, low voltage and low phase requirement ink to give an extremely clear, clean, high quality images even on coated stock.

Ingredients

Water—

The regular drinking water can be used for this purpose, however, it is preferred to use the de-ionized water since they do not contain unknown dissolved salts.

Dyes—

The dyes in the ink jet ink composition of the present invention is water soluble synthetic organic dye and preferably selected from the group consisting of direct dyes, acid dyes, basic dyes, reactive dyes or food dyes containing upto 15% salt. The dyes even with the higher salt level contents, can be used, however, with use of such dyes, the shelf life of the inks, is substantially reduced, as chances of precipitation and thus clogging increase. In general, the concentration of the dye should be between about 0.1 % and 30% by weight, depending on the shade and darkness required and is preferably in the 2% to 10% range.

Dye is the product in the ink, which decides the color of the ink. Considering this, different dyes, can be used for getting different colors or color shades. For those skilled in the art, it is clear that all sorts of coloring matters, whether synthetic or natural Dye or Pigment, Organic or Inorganic can be used and thus the scope of this invention is not limited only to synthetic organic dyes.

Co-Solvent—

The co-solvents are products, which enhance the solubility of the dye in the ink. The co-solvents also help in drying of the ink faster on the substrate.

As per the present invention under consideration the co-solvents are present in the ink composition between 0.1% to upto 30%. The volume of the co-solvent in the ink depends on the quantity of the dye used and the solubility of the dye. It is preferably present in the ink in the range of 2% to 11%. The presence of co-solvent lower than 0.1% may result in, the ink undergoing precipitation, as the salt from the dye can cause the ink to precipitate and also the drying will be flakier than commercially required. On the other hand, if the presence of the co-solvent in the ink is higher than 30% the same may make the intensity of the ink go down as well give out a strong chemical odor during the printing process and bring about an adverse effect on the viscosity of the ink.

Kogation Agent

In the current method covered under the invention under consideration, various kogation agents, may be used to prevent clogging of the orifices or nozzles of the print head. The kogation agent is used in the ink in the range from 0% to upto 2.0%. The higher level of the kogation agent used may lead to a change in the viscosity of the ink.

In the current method covered under the invention under consideration, the other additives, such as pH modifiers, defoamers, viscosity modifiers, surface tension modifiers, conductivity modifiers, biocides etc are added in the ink composition as per the requirements i.e. for better shelf life of the ink.

The example of ink manufacturing, without limiting the scope of the invention, using the present invention is given below

In the example the word Dye means any coloring matter, soluble or insoluble, organic or inorganic, dye or pigment, natural or synthetic, can be used.

### EXAMPLE

The ratio of the ingredients to be used in the process of making the ink as per the present invention is (Percentage based on the final volume of the ink), The recipe of the ink will be as follows

| Product | % Weight |
|---|---|
| Dye with salt content upto 15% | 0.01% to 30% |
| Co-Solvents | 2% to 30% |
| Kogation Agent | 0% to 2% |
| Biocide | 0.01% to 0.5% |
| PH buffer | 0.01% to 3.0% |
| Conductivity agents | 0% to 3.0% |
| Defoamers | upto 1.0% |
| De-ionized Water | Balance |

The following is one embodiment of a black ink, prepared in accordance with the present invention:.

A water soluble dye, C.I. Acid black 194 containing 8% salt content (Sodium chloride and sodium sulphate mixture) was used, this dye is commercially available from Rex-tone Dyes & Intermediates Ltd., Munibai, India. A 5% solution of this dye is made using Distilled Water and the solution prepared is used as the Dye solution A in the example.

| Product | % Weight |
|---|---|
| Dye Solution A | 88.80% |
| 2-pyrrolidnone 99% | 4.45% |
| Tetra Ethylene Glycol 97% | 1.10% |
| Biocide | 0.05% |
| PH buffer & Defoamer | 0.2% |
| Conductivity agents | 0.30% |
| Deionised Water | Balance |

The said ink has a conductivity of 11.55 m. MHOS/cm, which is substantially higher than the conductivity of the existing inks. The range of conductivity of the existing inks as tested by us is between 0.1 to 7 m. MHOS/cm.

On using the above ink composition in a continuous ink jet printer, in which the print head that was installed on the machine, had the manufacturers recommendation of 139 Volts at Phase 8. The test was conducted as follows:

Running a quantity of coated paper stock to check the ability of the product i.e. the ink manufactured by the method considered under the invention under consideration, to check Running and Drying properties of the product for patent, verses the competition. Once this point was satisfactory and established keeping the phase constant at 8. The voltage was then lowered, by ten volts. At each change of voltage reduction, a quantity of coated paper was run to insure print quality and smudge resistance. This process continued until the ink failed at a setting of 100 volts, phase 8. At this point, the voltage was increased by increments of five volts, and then two volts until the print quality returned to an acceptable level at 127 volts. Further, at 127 volts, the process of reducing phase by two points began, until it reached to a failure, at four phase. Once again the process of increasing the phase was done, and finally up to six, it was found that, this is the optimal setting.

Thus, the ink manufactured with the process covered under the invention, under consideration, ran successfully at 127 Volts and Phase 6. Actually one may go to, as low as 110 Volts to get the generally acceptable print quality.

In another test carried out for the ink manufactured by the method as described in the invention under consideration with the same composition as mentioned in the present invention and using the same model of printer, however, with a different print head, i.e. with a print head recommendation of 133 Volts/Phase 8 the ink manufactured under the current invention is able to run successfully at 125 Volts/Phase 6.

Further observations about the ink manufactured by the method, covered under the current invention, the said ink dries harder and faster than the currently available inks in the market. In this case, harder is defined as the ink's ability to dry over a press varnish without smearing or rubbing off.

The invention under consideration has been described in details with a particular reference to the certain preferred embodiments thereof but it will be understood that modifications and variations can be effected within the spirit and scope of the invention under consideration.

I claim:

1) A Water Based(aqueous) Liquid ink and its manufacturing process for use in different types of ink jet printers, composition comprising 0.1 to 12% of a Synthetic organic Dye with salt content upto 15%, also containing, Co-Solvents with percentage by weight of 2% to 30%, Kogation Agent with percentage by weight of 0% to 2%, Biocides, defoamers, surface tension modifers with percentage by weight of 0.01% to upto 0.5% each, pH buffer with percentage by weight of 0.01% to 3.0%, Conductivity agents with percentage by weight of 0% to 3.0% and the balance being Deionised Water.

2) A water based (aqueous) liquid ink for use in different types of ink jet printers composition as claimed in claim 1, wherein the Synthetic Organic Dye with a salt content upto 15% is used.

3) A water based (aqueous) liquid ink for use in different types of ink jet printers composition as claimed in claim 1, wherein the Co-Solvents with percent by weight of upto 30% is present.

4) A water based (aqueous) liquid ink for use in different types of ink jet printers composition as claimed in claim 1, wherein the Kogation Agent with percent by weight of about 2% is present.

5) A water based (aqueous) liquid ink for use in different types of ink jet printers composition as claimed in claim 1, wherein the Biocide with percent by weight of about 0.5% is present.

6) A water based (aqueous) liquid ink for use in different types of ink jet printers composition as claimed in claim 1, wherein the PH buffer with percent by weight of about 3.0% is present.

7) A water based (aqueous) liquid ink for use in different types of ink jet printers composition as claimed in claim 1, wherein the Conductivity agents with percent by weight of UPTO 3.0% is present.

8) A water based (aqueous) liquid ink for use in different types of ink jet printers composition as claimed in claim 1, wherein the balance being Deionised Water is present.

9) A water based (aqueous) liquid ink for use in different kinds of inkjet printers, having a conductivity range between 8.5 to 24 m. MHOS/cm.
